(19) United States
(12) Patent Application Publication
(10) Pub. No.: US 2022/0305564 A1
(43) Pub. Date: Sep. 29, 2022

(54) PROCESS, TOOL HOLDER AND DEVICE FOR TURNING WORKPIECES

(71) Applicant: Licardor GmbH, Oetwil an der Limmat (CH)

(72) Inventors: Felix Aschwanden, Oetwil an der Limmat (CH); Marcus Längerer, Ludwigsburg (DE)

(73) Assignee: Licardor GmbH, Oetwil an der Limmat (CH)

(21) Appl. No.: 17/696,522

(22) Filed: Mar. 16, 2022

(30) Foreign Application Priority Data
Mar. 23, 2021 (EP) 21164282.2

(51) Int. Cl. B23B 5/28; B24B 13/01

(52) U.S. Cl. CPC B23B 5/28; B24B 13/01; B23B 2215/08

(57) ABSTRACT

The invention relates to a method, a tool receptacle (13), and an apparatus for turning a face of a workpiece (2, 102) with a tool (3), wherein the workpiece (2, 102) is held in a workpiece receptacle (12) rotating about an axis of rotation (100) of a workpiece spindle, wherein, for producing and/or machining a workpiece contour having convex and/or concave portions on the face (20) that extend over defined angles of rotation, the tool (3) and the workpiece (2, 102) are moved back and forth relative to one another in an axial movement along the axis of rotation (100) of the workpiece spindle, said axis being synchronized with the rotational movement of the workpiece (2, 102), and wherein a blade (30) of the tool (3) is aligned at least in the cutting direction and/or transverse to the cutting direction opposite to the surface normals (N) of the workpiece contour to be produced and/or machined, in such a way that an effective clearance angle (α) and an effective cutting angle (γ) remain at least virtually constant opposite to the surface normals (N). The invention relates to a workpiece (2, 102) having a turned face.

### FIELD OF APPLICATION AND PRIOR ART

The invention relates to a method, a tool receptacle, and an apparatus for turning a face of a workpiece with a tool. The invention relates to a workpiece having a turned front side.

For example, the workpiece is a vehicle wheel or a wheel spider for the former, having a base body made of cast or forged metal, whose side facing away from the vehicle is referred to as the front side in the context of the application. In the context of the application, the vehicle-facing side is referred to as the reverse side. The front side and the rear side are collectively referred to as the face. In the context of the application, the vehicle wheel is understood to mean the entirety of the rim and wheel spider. The wheel spider is also referred to as the wheel disk. It is known to provide surfaces that are turned on the side of the wheel facing away from the vehicle, i.e., on the side visible in the assembled state, for improvement of the aesthetic impression, wherein, for the production of such surfaces, a base body of the vehicle wheel rotates about its center axis, while on the side facing away from the vehicle, a machining is carried out by a lathe tool. For example, from DE 10 2015 004 652 A1, a turning method for turning a vehicle wheel having a center axis is known, wherein the vehicle wheel is rotated about the center axis and, for producing convex and/or concave structures on the side of the vehicle wheel facing away from the vehicle, said structures extending over defined angles of rotation, a periodic or recurring advance movement along the center axis is carried out with the tool, the period term or recurrence term of which is tuned to an instantaneous circulation term of the rotational motion.

Alternatively, the workpiece is an optical workpiece, such as an optical lens or eyeglass. For example, from DE 10 2004 037 454 A1, a process for the machining of surfaces of optical workpieces, such as optical lenses or eyeglasses, with a tool is known, wherein a workpiece is received in a workpiece receptacle rotating about an axis of a workpiece spindle in such a way that the axis of rotation of the workpiece spindle runs at a distance to a workpiece axis of the workpiece.

These workpieces have in common that they have faces on which—for aesthetic reasons or for correcting blurred vision—a workpiece contour having concave or convex portions with a high surface quality is to be provided.

### Problem and Solution

It is a problem of the invention to create a method, a tool receptacle, and an apparatus for generating a workpiece contour having convex and/or concave portions on a face of a workpiece by means of turning, wherein the workpiece contour has a high, consistent surface quality. It is a further problem of the invention to create a workpiece having a machined surface.

According to a first aspect, a method for turning a face of a workpiece with a tool is created, wherein the workpiece is held in a workpiece receptacle rotating about an axis of rotation of a workpiece spindle, wherein, for producing and/or machining a workpiece contour having convex and/or concave portions on the face, the tool and the workpiece are moved back and forth relative to one another in an axial movement along the axis of rotation of the workpiece spindle, said axis being synchronized with the rotational movement of the workpiece, and wherein a blade of the tool is aligned in the cutting direction and/or transverse to the cutting direction opposite to the surface normals of the workpiece contour to be produced and/or machined, in such a way that an effective clearance angle and an effective cutting angle remain at least virtually constant opposite to the surface normals.

In the context of the application, the terms “a,” “an,” etc. are used merely as indefinite articles and not as keywords. The terms “first,” “second,” etc. serve merely to distinguish elements only and do not indicate a hierarchy of the elements. In particular, it is conceivable to machine a plurality of workpieces simultaneously and/or to machine one or more workpieces using two or more tools.

In the context of the application, the face is understood to mean a side of the workpiece to be machined, this side being aligned at least substantially perpendicular to the axis of rotation of the workpiece spindle. This is, for example, a front side of a vehicle wheel or its rear side, wherein ventilation openings on the rear side of the vehicle wheel are exposed by means of turning.

In one configuration, for a turning, the tool is arranged at an offset with respect to the axis of rotation. In order to produce convex and/or concave portions on the face, the workpiece and the tool are moved back and forth relative to one another along the axis of rotation. In one configuration, the workpiece is moved for this purpose. Alternatively or additionally, in other configurations, the tool is moved along the axis of rotation of the tool spindle. Due to the relative movement along the axis of rotation, it is possible, for example, to create a vehicle wheel that has oblique spokes for improved air cooling, as known for vehicle wheels, for example from FR 581 308.

For a high surface quality, the tool is aligned opposite to the surface normals when producing convex and/or concave structures. In one configuration, the blade is aligned by a corresponding inclination of the tool. In another configuration, only the blade is moved relative to a holder of the tool for an alignment of the blade.

With a conventional, more or less rigid clamping of the tool with respect to the rotational plane of the lathe, the cutting and clearance angles of the blade of the tool change opposite to the surface to be machined. As a result, the chip formation and chip flow conditions constantly change, which can negatively influence the surface quality.

By aligning the blade in the cutting direction and/or transverse to the cutting direction, it is possible to reduce a change in the chip formation and chip flow conditions during a revolution and thus increase a surface quality.

In one configuration, the blade of the tool is aligned transverse to the cutting direction opposite to the surface normals of the workpiece contour to be produced. Here, “transverse to the cutting direction” is understood to mean a direction which, in a plane perpendicular to the surface normals of the workpiece contour to be produced, includes an angle, in particular an angle of approx. 90°, with the cutting direction. By aligning transverse to the cutting direction, changes in the chip formation and chip flow conditions can be reduced during a machining or production of convex or concave structures in the radial direction.

Alternatively or additionally, in one configuration, for producing a workpiece contour having convex and/or concave portions on the face extending over defined angles of rotation, the tool and the workpiece are moved back and forth relative to one another in an axial movement along the axis of rotation of the workpiece spindle, said axis being synchronized with the rotational movement of the workpiece, wherein the blade of the tool is aligned in the cutting direction opposite to the surface normals of the workpiece contour to be produced.

In a further development, a rotational speed of the workpiece is varied during a revolution in such a way that a constant cutting speed within the scope of a tolerance range is realized. By varying the rotational speed, it is taken into account that, due to the concave or convex portions in the circumferential direction, a distance to be traversed with the tool over a defined angle of rotation changes.

In one configuration, it is provided that the tool is held stationarily in the radial direction of the workpiece spindle during a revolution, in such a way that the tool is guided relative to the workpiece along a circular tool path, also referred to as a machining track, which runs concentrically to the axis of rotation of the workpiece spindle. In another configuration, for generating a tool path that does not run concentrically to the axis of rotation of the workpiece spindle, the tool is moved back and forth during a revolution in the radial direction of the workpiece spindle.

Here, it is provided in a further development that the tool is aligned opposite the surface normals of the tool path. In other words, the tool is twisted such that it lies in the direction of the machining track. Thus, with tool paths that do not run concentrically to the axis of rotation of the workpiece spindle, and thus are not circular, the conditions during machining are improved. The tool path specifies the cutting direction, wherein, in the case of convex or concave portions, the tool is aligned in the cutting direction or transverse to the cutting direction.

In configurations of the method, the workpiece is held concentrically to the axis of rotation in the workpiece receptacle. In other configurations, the workpiece is held off-centered in the workpiece receptacle, wherein a workpiece axis is offset with respect to the axis of rotation.

In the case of an off-centered arrangement of the workpiece, compensation weights or the like are provided in one configuration. Alternatively or additionally, two or more workpieces are held off-centered in the workpiece receptacle, wherein the workpiece axes of the workpieces are offset with respect to the axis of rotation. As a result, two or more workpieces can be machined simultaneously.

In a further development, it is provided that the off-centered workpiece is rotated about the workpiece axis. In this way, contours with portions that are not concentric to one another can be created without a re-clamping of the workpiece.

According to a second aspect, a tool receptacle for a tool for turning a face of a workpiece is created, wherein the workpiece is held in a workpiece receptacle rotating about an axis of rotation, and wherein the workpiece comprises on the face a workpiece contour to be produced or machined, said contour having convex and/or concave portions, wherein the tool receptacle is designed in order to align a blade of the tool in the cutting direction and/or transverse to the cutting direction opposite to the surface normals of the workpiece contour to be produced and/or machined, in such a way that an effective clearance angle α and an effective cutting angle γ remain at least virtually constant opposite the surface normals.

According to a third aspect, an apparatus for turning a face of a workpiece with a tool is created, comprising a workpiece receptacle rotating about an axis of rotation of a workpiece spindle, said receptacle being designed in order to hold the workpiece, and a tool receptacle designed in order to hold the tool, wherein, for producing or machining a workpiece contour having convex and/or concave portions on the face, the workpiece receptacle and/or the tool receptacle is designed in order to move the tool and the workpiece back and forth relative to one another in an axial movement along the axis of rotation of the workpiece spindle, said axis being synchronized with the rotational movement of the workpiece, wherein the tool receptacle is further designed in order to align a blade of the tool in the cutting direction and/or transverse to the cutting direction opposite to the surface normals of the workpiece contour to be produced and/or machined, in such a way that an effective clearance angle and an effective cutting angle remain at least virtually constant opposite to the surface normals.

In one configuration, the tool receptacle is a support structure having six degrees of freedom, wherein, for a movement of the tool receptacle, a suitable kinematics is provided, being selected in particular from the group comprising a hexapod, a quadropod, and a multi-axis robot kinematics. Depending on the configuration, the tool receptacle is arranged laterally next to the workpiece receptacle or opposite to the workpiece receptacle.

In one configuration, the blade is aligned by a corresponding inclination of the tool. In another configuration, the tool receptacle is designed in order to move the tool along one or two rectilinear feed direction(s) and to move the blade relative to a holder of the tool for an alignment of the blade. In one configuration, a setting device having a programmable control is provided for a movement of the tool and/or the blade of the tool.

In one configuration, two or more tool receptacles are provided for simultaneous turning with a plurality of tools.

In one configuration, the tool receptacle is designed in order to align the blade of the tool transverse to the cutting direction opposite to the surface normals of the workpiece contour to be produced. Depending on the configuration, the tool receptacle is designed in order to move the tool including the blade or just the blade.

Alternatively or additionally, for producing a workpiece contour having convex and/or concave portions on the face extending over defined angles of rotation, the workpiece receptacle and/or the tool receptacle are designed in order to move the tool and the workpiece back and forth relative to one another in an axial movement along the axis of rotation of the workpiece spindle, said axis being synchronized with the rotational movement of the workpiece, wherein the tool receptacle is further designed in order to align a blade of the tool in the cutting direction opposite to the surface normals of the workpiece contour to be produced.

In one configuration, the apparatus is further designed in order to vary a rotational speed of the workpiece in such a way that a constant cutting speed within the scope of a tolerance range is realized.

In one configuration, for generating a tool path that does not run concentrically to the axis of rotation of the workpiece spindle, the tool receptacle is further designed in order to move the tool back and forth during a revolution in the radial direction, wherein the tool receptacle is designed in particular in order to align the tool opposite to the surface normals of the tool path.

In one configuration, the workpiece receptacle is further designed in order to center the workpiece. Alternatively or additionally, the workpiece receptacle is designed in order to hold the workpiece off-centered in the workpiece receptacle, wherein a workpiece axis is offset with respect to the axis of rotation. Due to the off-centered clamping, it is possible to create non-rotationally symmetrical contours. In one configuration, the workpiece receptacle is designed in order to hold two or more workpieces off-centered in the workpiece receptacle, wherein the workpiece axes of the workpieces are offset with respect to the axis of rotation.

In one configuration, the workpiece receptacle is further designed in order to rotate the off-centered workpiece about the workpiece axis. This allows contours having portions that are not concentric to one another to be created without a re-clamping of the workpiece.

According to a fourth aspect, a workpiece with a machined face is obtained by a method described above. The workpiece is, for example, a vehicle wheel or a wheel spider having a base body made of cast or forged metal, or optical workpieces such as optical lenses or glasses. This list is not exhaustive.

### BRIEF DESCRIPTION OF THE DRAWINGS

Other advantages and aspects of the invention arise from the claims and from the description of exemplary embodiments of the invention, which are explained below by way of the schematic figures. In the figures, the same reference numbers are used for the same or similar elements. The following are shown:

FIG. 1 a first exemplary embodiment of an apparatus for turning a face of a workpiece with a tool,

FIG. 2 a first exemplary embodiment of a workpiece with a turned face having concave portions extending over defined angles of rotation;

FIG. 3 an alignment of a blade of a tool opposite to the surface normals of the workpiece contour according to FIG. 2,

FIG. 4 a second exemplary embodiment of an apparatus for turning a face of a workpiece with a tool,

FIG. 5 a third exemplary embodiment of an apparatus for turning a face of a workpiece with a tool,

FIG. 6 an exemplary embodiment of non-rotationally symmetrical tool paths;

FIG. 7 a further exemplary embodiment of non-rotationally symmetrical tool paths similar to FIG. 6;

FIG. 8 a further exemplary embodiment of non-rotationally symmetrical tool paths similar to FIG. 6;

FIG. 9 an exemplary embodiment of a workpiece contour having multiple centers of rotation;

FIG. 10 a workpiece receptacle for an apparatus for turning a face of a workpiece with a tool.

### DETAILED DESCRIPTION OF THE EXEMPLARY EMBODIMENTS

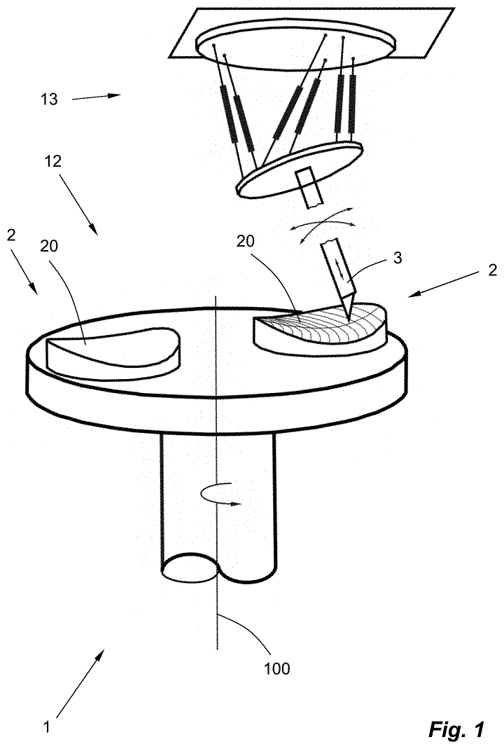

FIG. 1 shows a very schematic view of a first exemplary embodiment of an apparatus 1 for turning a face 20 of a workpiece 2 with a tool 3, in particular with a lathe tool.

The apparatus 1 comprises a workpiece receptacle 12, which is driven for machining the workpiece 2 for rotation about an axis of rotation 100 of a workpiece spindle (not shown). The workpiece receptacle 12 is designed in order to hold the workpiece 2. In the exemplary embodiment shown in FIG. 1, two workpieces 2 are held by means of the workpiece receptacle 12, wherein both workpieces 2 are held off-centered, i.e., not concentrically to the axis of rotation 100.

The apparatus 10 further comprises a tool receptacle 13, which is designed in order to hold the tool 3.

For a turning of a face 20 of the workpiece 2 being aligned at least substantially perpendicular to the axis of rotation 100, it is known to place the tool radially to the axis of rotation 100 and/or along the axis of rotation 100 after each revolution of the workpiece receptacle 12.

The illustrated tool receptacle 13 is further designed in order to align a blade of the tool 3 in the cutting direction and transverse to the cutting direction opposite to the surface normals of the workpiece contour to be produced.

The illustrated tool receptacle 13 comprises a hexapod for this purpose. A hexapod is advantageous, because it is suitable to hold the tool with a high rigidity for a machining. However, the invention is not limited to the use of a hexapod.

The apparatus 1 according to FIG. 1 is suitable for carrying out a method, wherein, during a turning, the blade of the tool 3 is aligned in the cutting direction and/or transverse to the cutting direction opposite to the surface normals of the workpiece contour to be produced and/or machined, in such a way that an effective clearance angle and an effective cutting angle remain at least virtually constant opposite to the surface normals. By aligning the blade of the tool 3, a surface having a high surface quality is created.

In the exemplary embodiment according to FIG. 1, the workpiece receptacle 12 is designed in order to receive two workpieces 2 in such a way that two workpieces 2 can be machined simultaneously. However, this configuration is merely exemplary. In an alternative configuration, the workpiece receptacle 12 is designed in order to receive exactly one workpiece 2 for the machining thereof. Depending on the application, the workpiece can be received centered to the axis of rotation 100 or off-centered.

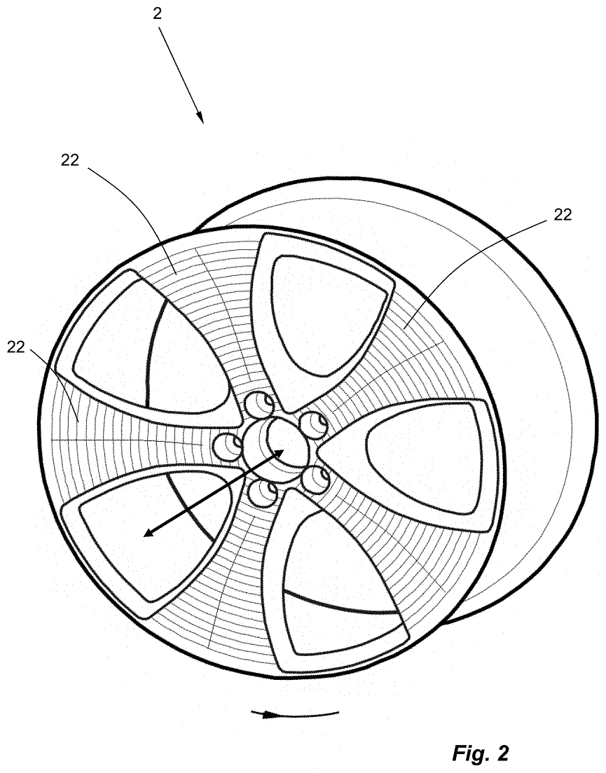

FIG. 2 schematically shows an exemplary embodiment of a workpiece 2 configured as a vehicle wheel having five spokes 22, which, on its face 20 visible in FIG. 2, has a workpiece contour produced or machined by means of turning.

The spokes 22 are respectively configured in a ball-like manner, i.e., a workpiece contour of the workpiece 2 shown in FIG. 2 has convex portions that extend over defined angles of rotation and are provided in the region of the spokes 22. To produce the former, the vehicle wheel 2 and/or a tool receptacle 12 receiving the vehicle wheel 2 during the turning (cf. FIG. 1) carry out an axial movement (indicated by a double arrow) along the axis of rotation 100 (cf. FIG. 1) of the workpiece spindle during a rotation of the workpiece 2, said movement being synchronized with the rotational movement of the workpiece 2, indicated by an arrow in FIG. 2.

For an improved surface quality, the blade of tool 3 (cf. FIG. 1) is aligned in the cutting direction opposite to the surface normals of the workpiece contour to be produced.

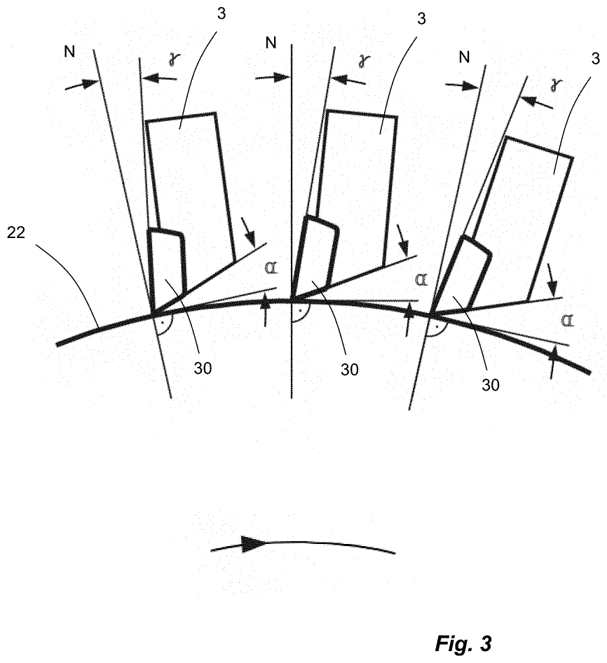

FIG. 3 schematically shows a lateral view of a spoke 22 of the workpiece 2 according to FIG. 2 and a tool 3 guided along the spoke 22 during the machining. As shown in FIG. 3, in the illustrated exemplary embodiment, the tool 3 is aligned with the blade 30 in the cutting direction compared to the surface normals N of the workpiece contour to be produced and/or machined, in such a way that an effective clearance angle α and an effective cutting angle γ remain at least virtually constant opposite to the surface normals N. By contrast to conventional apparatuses, in which a tool 3 is held rigidly and thus the effective clearance angle α and the effective cutting angle γ opposite to the surface normals N change when producing or machining concave or convex portions, chip formation conditions can thus be kept virtually constant.

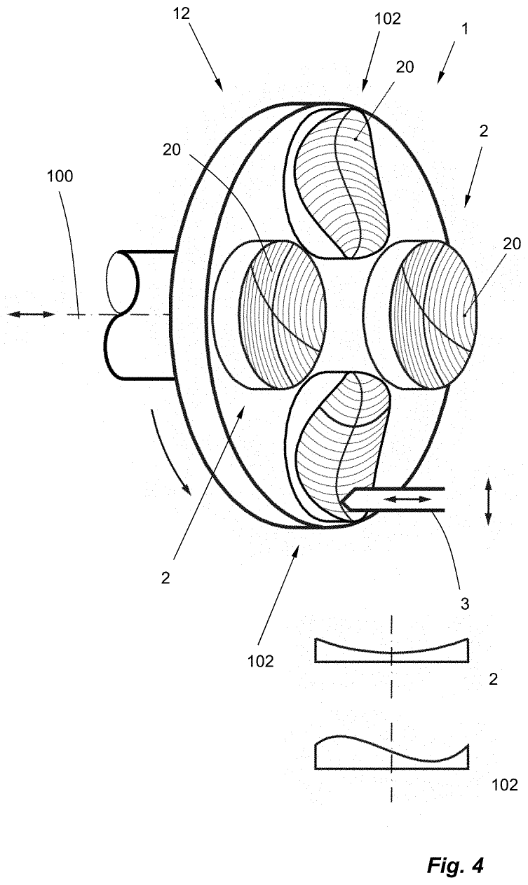

FIG. 4 shows a second exemplary embodiment of an apparatus 1 for turning a face 20 of a workpiece 2, 102 with a tool 3. In the exemplary embodiment according to FIG. 4, four workpieces 2, 102 are held by means of the workpiece receptacle 12 and machined simultaneously. Two of the illustrated workpieces 2 have a concave workpiece contour, and two workpieces 102 have a contour that comprises concave and convex portions. The illustrated contours are merely exemplary. Due to a suitable axial movement of the tool 3 along the axis of rotation 100, said movement being synchronized with the rotational movement about the axis of rotation 100, a simultaneous machining of the workpieces 2, 102 along circular tool paths, which run concentrically with respect to the axis of rotation 100, is possible. In order to produce a machined surface with a high surface quality, at least one blade of the tool 3 is aligned as described above in the cutting direction or transverse to the cutting direction opposite to the surface normals of the workpiece contour to be produced and/or machined.

FIG. 5 shows a third exemplary embodiment of an apparatus 1 for turning a face 20 of a workpiece 2 with a tool 3, similar to FIG. 1, having a workpiece receptacle 12 and a tool receptacle 13. By contrast to the exemplary embodiment according to FIG. 1, in the exemplary embodiment according to FIG. 5 the tool receptacle 13 is not arranged opposite to the workpiece receptacle 12, but rather laterally to the workpiece receptacle 12. However, the tool receptacle 13 shown is also designed in order to align a cut of the tool 3 in the cutting direction and transverse to the cutting direction opposite to the surface normals of the workpiece contour to be produced.

In the arrangements shown in FIGS. 1, 4, and 5, the apparatuses 1 are respectively used in order to machine the workpieces 2 along circular tool paths running concentrically to the axis of rotation, wherein a distance of the tool 3 from the axis of rotation 100 remains constant. However, in order to produce or machine a tool path that does not run concentrically to the axis of rotation 100 of the workpiece spindle, the apparatuses shown are also suitable for moving the tool 3 back and forth in the radial direction of the workpiece spindle during a revolution. For a high surface quality, the tool 3 is aligned opposite to the surface normals of the tool path.

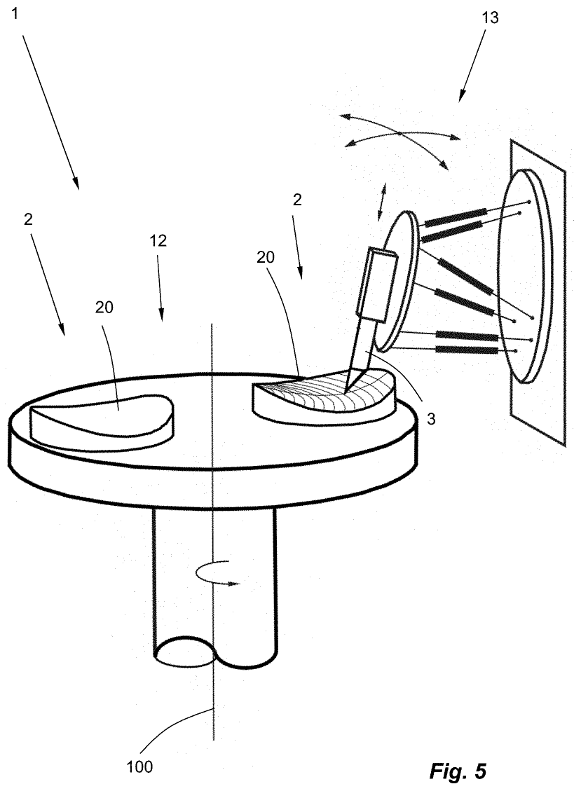

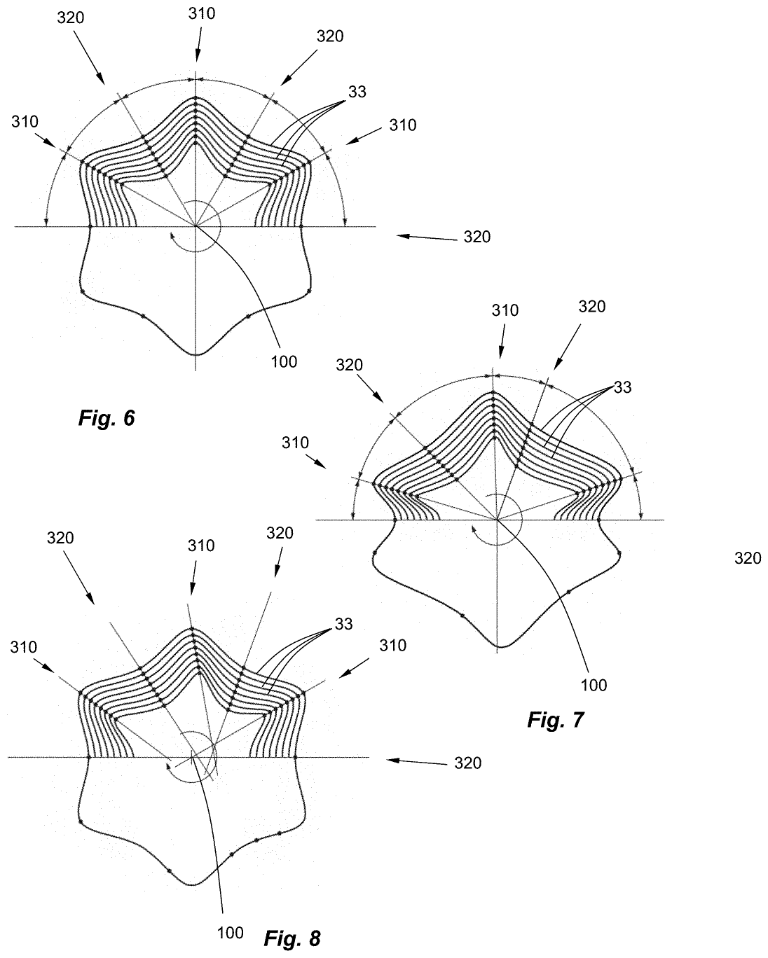

FIG. 6 schematically shows an exemplary embodiment having a plurality of tool paths 33 that are non-rotationally symmetrical and do not run concentrically to the axis of rotation 100 of the workpiece spindle. To generate these tool paths 30, the tool 3 (cf. FIG. 1 or 5) is moved back and forth during a revolution in the radial direction of the workpiece spindle. The tool paths 33 according to FIG. 6 have a common central point that coincides with the axis of rotation 100. In addition, the minima 320 and maxima 310 of the tool paths 33 are evenly distributed over the circumference.

FIG. 7 shows a further exemplary embodiment having a plurality of tool paths 33 that are not rotationally symmetrical and do not run concentrically to the axis of rotation 100 of the workpiece spindle, similar to FIG. 6. By contrast to the exemplary embodiment according to FIG. 6, in the configuration according to FIG. 7, minima 320 and maxima 310 of the tool paths 33 are not evenly distributed over the circumference. An offset of the angle of rotation between the minima 320 and the maxima 310 is selected uniformly for all tool paths.

FIG. 8 shows a further exemplary embodiment having multiple tool paths 33 that are not rotationally symmetrical and do not run concentrically to the axis of rotation 100 of the workpiece spindle, similar to FIG. 6. By contrast to the exemplary embodiment according to FIG. 6, in the configuration according to FIG. 7, minima 320 and maxima 310 of the tool paths 33 are not evenly distributed over the circumference. Further, the minima 320 and maxima 310 of different tool paths 33 are offset with respect to one another in such a way that the straight lines connecting the minima 320 and maxima 310 do not intersect the axis of rotation 100.

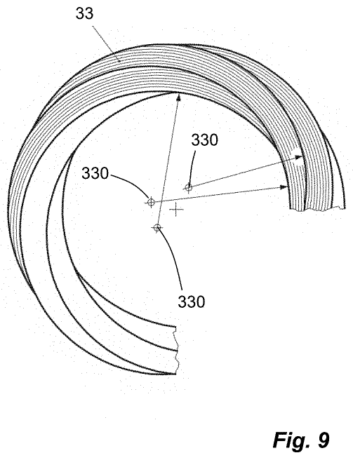

FIG. 9 shows an exemplary embodiment of a non-rotationally symmetrical workpiece contour. The workpiece contour according to FIG. 9 has tool paths 33, which respectively run concentrically to different centers of rotation 330. To produce a tool contour according to FIG. 9 with an apparatus shown, for example, in FIG. 1, 4, or 5, a workpiece 2 is received by means of the tool receptacle 12 in such a way that a center of rotation 330 coincides with the axis of rotation 100. After generating the tool paths 33 concentric to this center of rotation 330, the workpiece 2 is offset in such a way that a further center of rotation 330 coincides with the axis of rotation 100. In one configuration, an offset occurs manually at the tool receptacle 12. In another configuration, the tool receptacle is embodied and designed in order to offset a received workpiece 2 in a plane perpendicular to the axis of rotation 100.

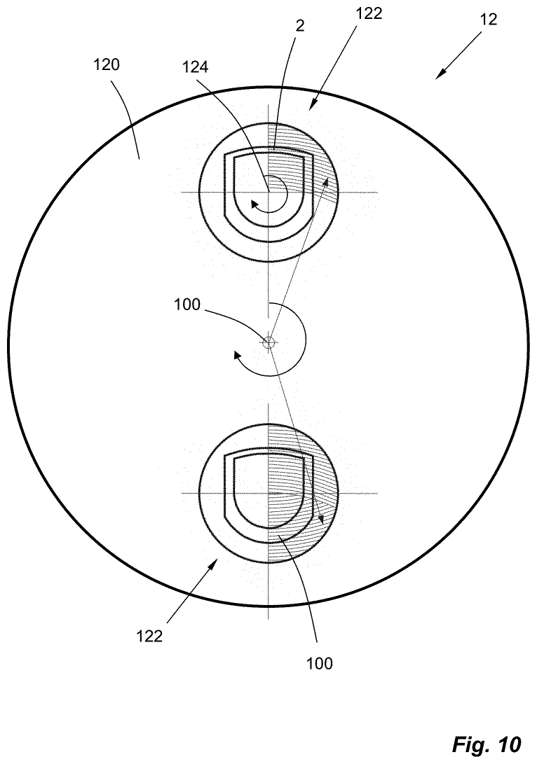

FIG. 10 schematically shows a workpiece receptacle 12 for an apparatus 1 (cf. FIGS. 1, 4, and 5) for turning a face 20 of a workpiece 2 with a tool not shown in FIG. 10 in a top view. The workpiece receptacle 12 according to FIG. 10 comprises a base plate 120 rotating about the axis of rotation 100. At least one off-centered storage device 122 is provided on the base plate 120. In the illustrated exemplary embodiment, two off-centered storage devices 122 are provided, at which a workpiece 2 is respectively received. In the configuration according to FIG. 10, the storage devices 122 can each be rotated about an axis of rotation 124 as indicated by an arrow. By rotating the storage devices 122, there arise further configuration possibilities for generating complex tool contours without the need for a re-clamping of the workpieces 2. The axes of rotation 124 of the storage device 122 are also referred to as the workpiece axes 124.

The illustrated exemplary embodiments are merely exemplary, and numerous variations are possible in order to realize a turning of a face of a workpiece 2 in which the blade is aligned with the surface normals. The machining of rotationally symmetrical as well as non-rotationally symmetrical components is conceivable.

1. A method for turning a face of a workpiece with a tool, wherein the workpiece is held in a workpiece receptacle rotating about an axis of rotation of a workpiece spindle, wherein, for producing or machining a workpiece contour having convex and/or concave portions on the face, the tool and the workpiece are moved back and forth relative to one another in an axial movement along the axis of rotation of the workpiece spindle, said axis being synchronized with the rotational movement of the workpiece, wherein a blade of the tool is aligned in the cutting direction and/or transverse to the cutting direction opposite to the surface normals of the workpiece contour to be produced and/or machined, in such a way that an effective clearance angle α and an effective cutting angle γ remain at least virtually constant opposite to the surface normals.

2. The method for turning according to claim 1, wherein, for producing a workpiece contour having convex and/or concave portions on the face extending over defined angles of rotation, the tool and the workpiece are moved back and forth relative to one another in an axial movement along the axis of rotation of the workpiece spindle, said axis being synchronized with the rotational movement of the workpiece, wherein the blade of the tool is aligned in the cutting direction opposite to the surface normals of the workpiece contour to be produced and/or machined.

3. The method for turning according to claim 1, wherein a rotational speed of the workpiece is varied during a revolution in such a way that a constant cutting speed within the scope of a tolerance range is realized.

4. The method for turning according to claim 1, wherein, for generating a tool path that does not run concentrically to the axis of rotation of the workpiece spindle, the tool is moved back and forth during a revolution in the radial direction of the workpiece spindle, wherein the tool is aligned opposite to the surface normals of the tool path.

5. The method for turning according to claim 1, wherein the workpiece is held off-centered in the workpiece receptacle, wherein a workpiece axis is offset with respect to the axis of rotation.

6. The method for turning according to claim 5, wherein two or more workpieces are held off-centered in the workpiece receptacle, wherein the workpiece axes of the workpieces are offset with respect to the axis of rotation.

7. The method for turning according to claim 5, wherein the off-centered workpiece is rotated about the workpiece axis.

8. A tool receptacle for a tool for turning a face of a workpiece, wherein the workpiece is held in a workpiece receptacle rotating about an axis of rotation, and wherein the workpiece comprises on the face a workpiece contour to be produced or machined, said contour having convex and/or concave portions, wherein the tool receptacle is designed in order to align a blade of the tool in the cutting direction and/or transverse to the cutting direction opposite to the surface normals of the workpiece contour to be produced and/or machined, in such a way that an effective clearance angle α and an effective cutting angle γ remain at least virtually constant opposite the surface normals.

9. The tool receptacle according to claim 8, wherein, for producing and/or machining the workpiece contour having convex and/or concave portions on the face extending over defined angles of rotation, the tool receptacle is designed in order to move the tool back and forth relative to the workpiece in an axial movement along the axis of rotation, said axis being synchronized with the rotational movement of the workpiece, wherein the tool receptacle is further designed in order to align a blade of the tool in the cutting direction opposite to the surface normals of the workpiece contour to be produced.

10. The tool receptacle according to claim 8, wherein, for generating a tool path that does not run concentrically to the axis of rotation, the tool receptacle is designed in order to move the tool back and forth during a revolution in the radial direction, and wherein the tool receptacle is designed in order to align the tool opposite to the surface normals of the tool path.

11. An apparatus for turning a face of a workpiece with a tool, with a workpiece receptacle rotating about an axis of rotation of a workpiece spindle, said receptacle being designed in order to hold the workpiece, and with a tool receptacle designed in order to hold the tool, wherein, for producing or machining a workpiece contour having convex and/or concave portions on the face, the workpiece receptacle and/or the tool receptacle is designed in order to move the tool and the workpiece back and forth relative to one another in an axial movement along the axis of rotation of the workpiece spindle, said axis being synchronized with the rotational movement of the workpiece, wherein the tool receptacle is further designed in order to align a blade of the tool in the cutting direction and/or transverse to the cutting direction opposite to the surface normals of the workpiece contour to be produced and/or machined, in such a way that an effective clearance angle α and an effective cutting angle γ remain at least virtually constant opposite to the surface normals.

12. The apparatus according to claim 11, wherein the workpiece receptacle is designed in order to vary a rotational speed of the workpiece in such a way that a constant cutting speed within the scope of a tolerance range is realized.

13. The apparatus according to claim 11, wherein the workpiece receptacle is designed in order to hold the workpiece off-centered in the workpiece receptacle, wherein a workpiece axis is offset with respect to the axis of rotation.

14. The apparatus according to claim 11, wherein the workpiece receptacle is designed in order to hold two or more workpieces off-centered in the workpiece receptacle, wherein the workpiece axes of the workpieces are offset with respect to the axis of rotation.

15. The apparatus according to claim 13, wherein the workpiece receptacle is designed in order to rotate the off-centered workpiece about the workpiece axis.

16. A workpiece, in particular a vehicle wheel or an optical workpiece, having a machined face obtained through a method according to claim 1.
